(19) United States
(12) Patent Application Publication
(10) Pub. No.: US 2023/0369780 A1
(43) Pub. Date: Nov. 16, 2023

(54) On-Chip Antenna and Phased Array Antenna

(71) Applicant: Nippon Telegraph and Telephone Corporation, Tokyo (JP)

(72) Inventors: Go Itami, Musashino-shi, Tokyo (JP); Hiroshi Hamada, Musashino-shi, Tokyo (JP); Hideyuki Nosaka, Musashino-shi, Tokyo (JP)

(21) Appl. No.: 18/246,632

(22) PCT Filed: Sep. 29, 2020
(86) PCT No.: PCT/JP2020/036852

§ 371 Date: Mar. 24, 2023

(51) Int. Cl. H01Q 21/08; H01Q 13/08; H01Q 3/30

(52) U.S. Cl. CPC H01Q 21/08; H01Q 13/08; H01Q 3/30

(57) ABSTRACT

A patch conductor has a hexagonal shape as a whole in a plan view in which both corners of one side of a rectangle are obliquely cut off, and a connection portion located at a center of the side is connected to a feed line. In this way, an inclined portion inclined with respect to a direction X is formed between the side and a side of the patch conductor, and an inclined portion inclined with respect to the direction X is formed between the side and a side. This makes it possible to significantly improve directivity and gain and obtain a wideband radiation characteristic.

### TECHNICAL FIELD

The present invention relates to an on-chip antenna mounted on a semiconductor chip and a phased array antenna including the same.

### BACKGROUND ART

A wireless communication device such as a mobile terminal is strongly required to be large in capacity, small in size, and easily carried. In order to achieve those properties, it is important to widen bandwidths (which leads to an increase in data rate) of an antenna and a radio frequency electronic circuit (hereinafter, RF circuit) serving as a radio frequency (RF) front end of a wireless communication device included in a terminal and to reduce sizes of the antenna and the RF circuit. Here, the bandwidth of the RF front end is determined based on an operating bandwidth of high-frequency components including the antenna and analog circuits such as an amplifier and frequency converter serving as components of the RF front end.

Assuming that a ratio of the operating bandwidth of those high-frequency components to a center frequency of the operating band (referred to as a fractional bandwidth) is constant (this assumption is normally established: Non Patent Literature 1), the operating bandwidth can be increased by increasing a carrier frequency because the bandwidth is proportional to the carrier frequency. When the carrier frequency is increased, a wavelength of a radio signal is shortened. Thus, it is also possible to reduce sizes of components including the analog circuits and an impedance element (e.g. quarter-wave line) determined based on a wavelength of the antenna. Therefore, increasing the carrier frequency is effective as a method of meeting needs such as an increase in data rate of the wireless communication device and reduction in size thereof.

In view of this, in recent years, research on high-speed and small wireless communication devices using extremely and tremendously high frequencies such as millimeter waves and terahertz waves has been actively conducted. A problem in using millimeter waves and terahertz waves is a connection portion between a high frequency circuit and an antenna. When a method used in a low frequency band, such as wire bonding or a flip chip, is applied to the connection portion in a tremendously high frequency band exceeding 300 GHz, a large connection loss occurs due to inductance caused by a physical length of the connection portion. Using an on-chip antenna (Non Patent Literature 2) integrated on a semiconductor chip on which a high frequency circuit is formed can eliminate the connection portion between the high frequency circuit and the antenna. Thus, this is effective for reducing a loss in the tremendously high frequency band. Further, the on-chip antenna is manufactured by a semiconductor integration process and is therefore generally small. This also contributes to reduction in size of the wireless communication device.

Typical examples of the on-chip antenna include a patch antenna and slot antenna. An operation principle of those antennas is basically similar to that of a dipole antenna and is such that distributions of standing waves of voltage and current are formed on an antenna conductor pattern to radiate an electric field. The antennas are easily manufactured because of their simple structures, but generally have a narrow band characteristic determined by a Q factor of resonance because the antennas use a resonance phenomenon caused by formation of standing waves. Meanwhile, examples of an antenna having a wide bandwidth and relatively large directivity include a Vivaldi antenna. However, the antenna has a large structure whose size is about a wavelength and thus needs to be multilayered, for example, in order to perform beamforming. Therefore, the antenna is not suitably mounted as one chip.

### CITATION LIST

### Non Patent Literature

Non Patent Literature 1: G. Hau, T. B. Nishimura, and N. Iwata, “High Efficiency, Wide Dynamic Range Variable Gain and Power Amplifier MMICs for Wide-Band CDMA Handsets”, IEEE Microwave and Wireless Components Letters, Vol. 11, pp. 13-15, January 2001
Non Patent Literature 2: X. D. Deng, Y. Li, C. Liu, W. Wu and Y. Z. Xiong, “340 GHz On-Chip 3-D Antenna With 10 dBi Gain and 80% Radiation Efficiency”, IEEE Trans. Terahertz Sci. Technol, Vol. 5, pp. 619-627, July 2015
Non Patent Literature 3: C. kai and S. J. Chung, “A Compact Edge-Fed Filtering Microstrip Antenna with 0.2 dB Equal-Ripple Response”, in Proc. 39th Eur. Microw. Conf. (EuMC 2009), Rome, Italy, pp. 378-380, October 2009

### SUMMARY OF INVENTION

### Technical Problem

However, such a conventional structure has poor directivity and has substantially poor radiation efficiency of radiant power from an input to a specific reception direction. This reduces a transmission distance of a wireless transmission system including an antenna, which is problematic. Further, the conventional structure is a resonant system of a single frequency and thus has a peak at the single frequency as a frequency characteristic of radiation. Therefore, it is difficult to increase a bandwidth of the wireless transmission system including the antenna and to increase a transmission speed, which are also problematic.

Even in a case where a wideband on-chip antenna is designed as a solution to the above problems, the antenna needs to include a plurality of resonance structures. Therefore, there is a problem that a size of an element is increased, which makes it difficult to array the antennas. Similarly, there is also a problem that a gain in the band becomes unstable when the wideband on-chip antenna is designed.

The present invention has been made in order to solve the above problems, and an object thereof is to provide an on-chip antenna capable of significantly improving directivity and gain and obtaining a wideband radiation characteristic.

### Solution to Problem

In order to achieve such an object, an on-chip antenna according to the present invention includes: a substrate made from a dielectric; a patch conductor formed on a front surface of the substrate and configured to radiate a fed electromagnetic field; a feed line formed on the front surface of the substrate and configured to feed an input electromagnetic field to the patch conductor; and a pair of stub conductors formed on the front surface of the substrate and provided to symmetrically protrude from the feed line in the vicinity of a connection portion where the feed line is connected to the patch conductor, in which the patch conductor has a hexagonal shape in which both corners of one side of a rectangle are obliquely cut off, and the one side is connected to the feed line at the connection portion.

Further, a phased array antenna according to the present invention includes: a plurality of the on-chip antennas according to the present invention; and a plurality of feed lines configured to individually supply a high frequency signal to the plurality of on-chip antennas, respectively, in which: the plurality of on-chip antennas is periodically arrayed one-dimensionally or two-dimensionally at an interval of about a half wavelength of a radio wave in a target frequency band in a direction different from a feeding direction of the plurality of feed lines; and the plurality of feed lines individually feed each of a plurality of radio frequency signals having a same phase or different phases to a corresponding on-chip antenna of the plurality of on-chip antennas.

Further, a phased array antenna according to the present invention includes: a plurality of the on-chip antennas according to the present invention; and a plurality of feed lines configured to individually supply a high frequency signal to the plurality of on-chip antennas, respectively, in which: a structure in which the plurality of on-chip antennas is periodically arrayed one-dimensionally in a feeding direction of the plurality of feed lines serves as one unit, and the structures are periodically arrayed one-dimensionally or two-dimensionally in a direction different from the feeding direction of the plurality of feed lines; and the plurality of feed lines individually feed each of a plurality of radio frequency signals having a same phase or different phases to a corresponding on-chip antenna of the plurality of on-chip antennas.

### Advantageous Effects of Invention

According to the present invention, it is possible to significantly improve directivity and gain of an on-chip antenna and obtain a wideband radiation characteristic.

### BRIEF DESCRIPTION OF DRAWINGS

FIG. 1 is a plan view illustrating a configuration of an on-chip antenna according to a first embodiment.

FIG. 2 is a cross-sectional view taken along line I-I of FIG. 1.

FIG. 3 is an explanatory diagram of the on-chip antenna according to the first embodiment.

FIG. 4 is an explanatory diagram of an antenna size of the on-chip antenna according to the first embodiment.

FIG. 5 is a plan view illustrating a configuration of a conventional patch antenna.

FIG. 6 is a cross-sectional view taken along line II-II of FIG. 5.

FIG. 7 is an explanatory diagram of the conventional patch antenna.

FIG. 8 is an explanatory diagram of an antenna size of the conventional patch antenna.

FIG. 9 is an enlarged view of a port portion.

FIG. 10 is a cross-sectional view taken along line III-III of FIG. 9.

FIG. 11 is a graph showing changes (Angle_Patch) in return loss frequency characteristics regarding the on-chip antenna according to the first embodiment.

FIG. 12 is a graph showing changes (Pat_x) in return loss frequency characteristics regarding the on-chip antenna according to the first embodiment.

FIG. 13 is a graph showing changes (Pat_y) in return loss frequency characteristics regarding the on-chip antenna according to the first embodiment.

FIG. 14 is a graph showing a gain characteristic regarding the on-chip antenna according to the first embodiment.

FIG. 15 is a plan view illustrating a configuration of an on-chip antenna according to a second embodiment.

FIG. 16 is a cross-sectional view taken along line IV-IV of FIG. 1.

FIG. 17 is an explanatory diagram of an antenna size of the on-chip antenna according to the second embodiment.

FIG. 18 is a graph showing a return loss frequency characteristic regarding the on-chip antenna according to the second embodiment.

FIG. 19 is a graph showing a gain characteristic regarding the on-chip antenna according to the second embodiment.

FIG. 20 is a plan view illustrating a configuration of a phased array antenna including the on-chip antennas according to the second embodiment.

FIG. 21 is a perspective view of FIG. 20.

FIG. 22 is a graph showing return loss frequency characteristics regarding the phased array antenna according to the second embodiment.

FIG. 23 is a graph showing a gain characteristic regarding the phased array antenna according to the second embodiment.

FIG. 24 is a graph showing a radiation characteristic (front radiation) regarding the phased array antenna according to the second embodiment.

FIG. 25 is a graph showing a radiation characteristic (left radiation) regarding the phased array antenna according to the second embodiment.

FIG. 26 is a graph showing a radiation characteristic (right radiation) regarding the phased array antenna according to the second embodiment.

### DESCRIPTION OF EMBODIMENTS

Next, embodiments of the present invention will be described with reference to the drawings.

### First Embodiment

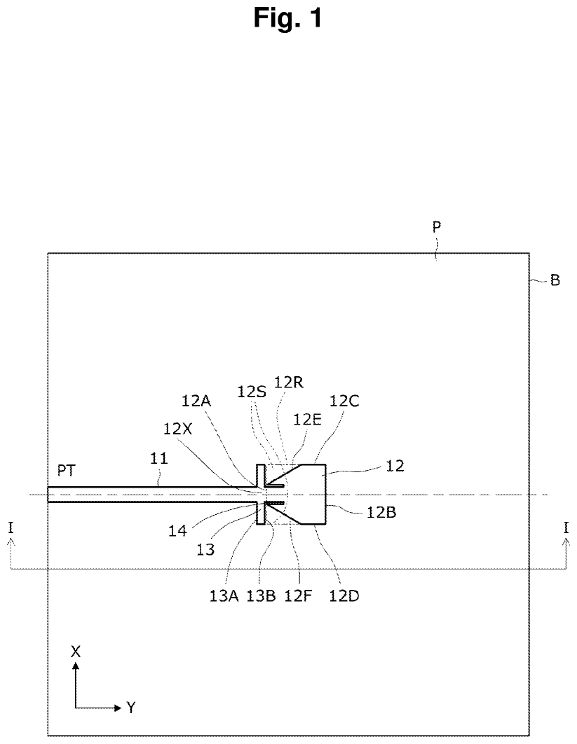

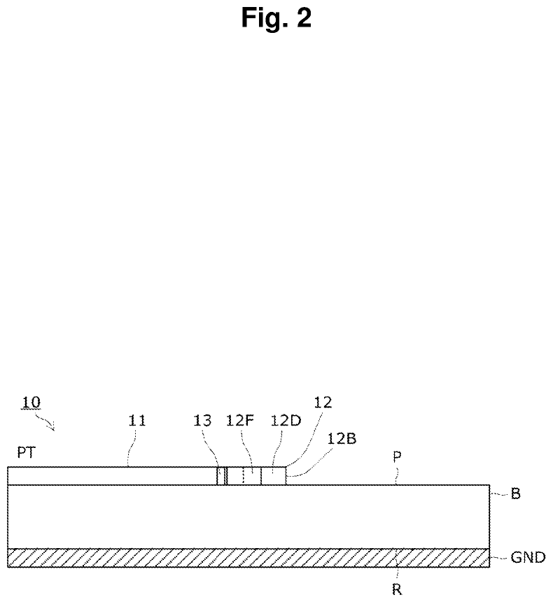

First, an on-chip antenna 10 according to a first embodiment of the present invention will be described with reference to FIGS. 1 and 2. FIG. 1 is a plan view illustrating a configuration of the on-chip antenna according to the first embodiment. FIG. 2 is a cross-sectional view taken along line I-I of FIG. 1.

The on-chip antenna 10 according to the present invention is an antenna formed on a dielectric substrate B on which a semiconductor chip of an integrated circuit such as a monolithic microwave integrated circuit (hereinafter, referred to as MMIC) is formed by using a general semiconductor process technology. Hereinafter, the on-chip antenna 10 will also be referred to as a circuit integrated antenna.

### On-Chip Antenna

As illustrated in FIGS. 1 and 2, the on-chip antenna 10 mainly includes a feed line 11, a patch conductor 12, and stub conductors 13 formed on a front surface P of the substrate B. As illustrated in FIG. 2, a ground plane GND is formed in at least a region facing the feed line 11, the patch conductor 12, and the stub conductors 13 on a bottom surface R of the substrate B.

### Feed Line

The feed line 11 includes a microstrip line as a whole and is a transmission line for feeding a high-frequency electromagnetic field input from the outside to the patch conductor 12. Hereinafter, for ease of description, a direction in which the feed line 11 extends on the front surface P (left and right direction on a surface of paper) will be referred to as a direction Y, and a direction orthogonal to the direction Y (up and down direction on the surface of the paper) will be referred to as a direction X.

### Patch Conductor

The patch conductor 12 is an antenna element (radiating element) that radiates an electromagnetic field fed from the feed line 11. The patch conductor 12 has a hexagonal shape as a whole in a plan view in which both corners 12S of one side 12A of a rectangle 12R are obliquely cut off. A connection portion 12X located at a center of the side 12A is connected to the feed line 11, and a side 12B facing the side 12A serves as an end of the patch conductor 12.

In this way, an inclined portion 12E inclined with respect to the direction X is formed between the side 12A and a side 12C of the patch conductor 12, and an inclined portion 12F inclined with respect to the direction X is formed between the side 12A and a side 12D.

### Stub Conductor

The stub conductors 13 are a pair of stubs provided to symmetrically protrude from the feed line 11 in the direction X in the vicinity of the connection portion 12X where the feed line 11 is connected to the patch conductor 12. A distance in the direction X between both ends of the stub conductors 13 is substantially the same as a distance in the direction X between the facing sides 12C and 12D of the patch conductor 12. Each of the stub conductors 13 has a certain conductor width equal to or less than a line width of the feed line 11. In the stub conductor 13, a side 13A on the feed line 11 side (a port PT side) and a side 13B on the patch conductor 12 side protrude from the feed line 11 in the direction X, i.e., in a direction perpendicular to the feed line.

Hereinafter, an example where the feed line 11 is linearly formed will be described. However, the present invention is not limited thereto, and a bent portion, curved portion, or another stub may be provided in the middle of the feed line. Further, an example where a substrate including a compound semiconductor such as indium phosphide (Inp) is used as the substrate B will be described. However, the present invention is not limited thereto, and a general dielectric substrate used for a high frequency circuit may be used. Furthermore, an example where a thin film of gold (Au) is used as a thin film conductor of the feed line 11, the patch conductor 12, the stub conductors 13, and the like will be described. However, the present invention is not limited thereto, and a general metal thin film conductor used for a high frequency circuit may be used.

### Operation Analysis According to First Embodiment

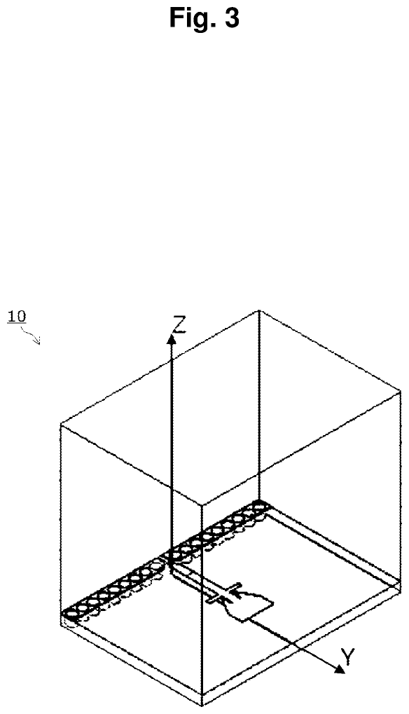

Next, an analysis result by simulation will be described as an operation of the on-chip antenna 10 according to the present embodiment with reference to FIGS. 3 to 11. Hereinafter, an analysis result regarding a conventional patch antenna will also be described for comparison.

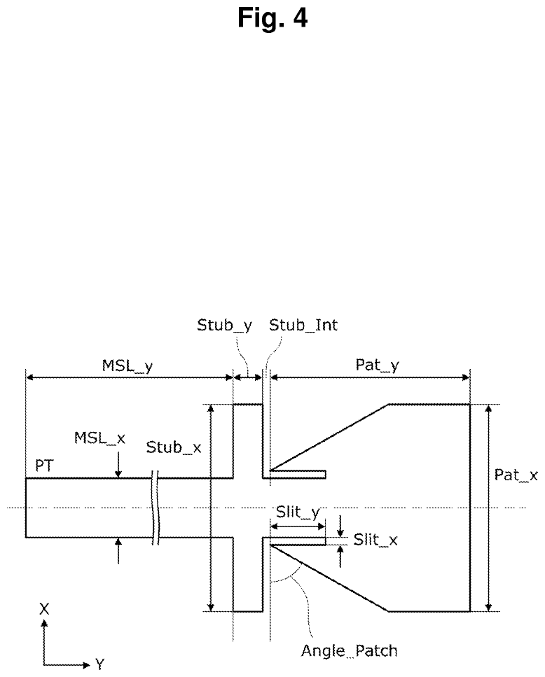

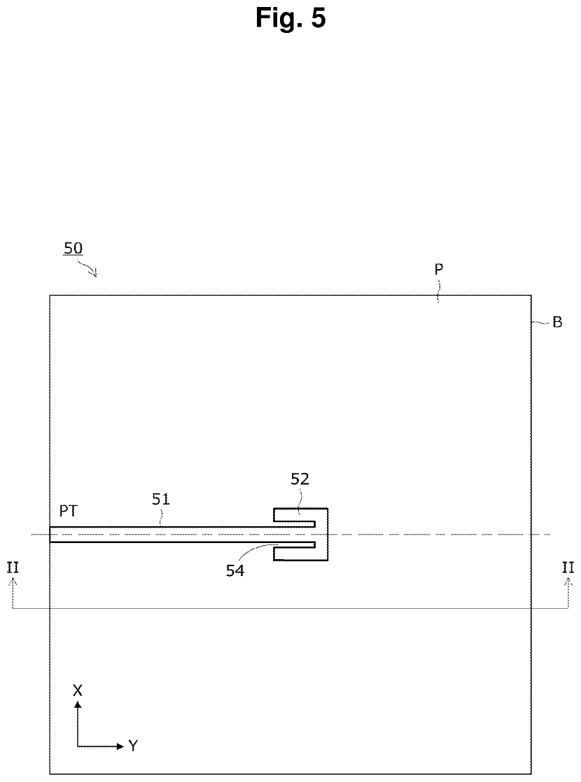

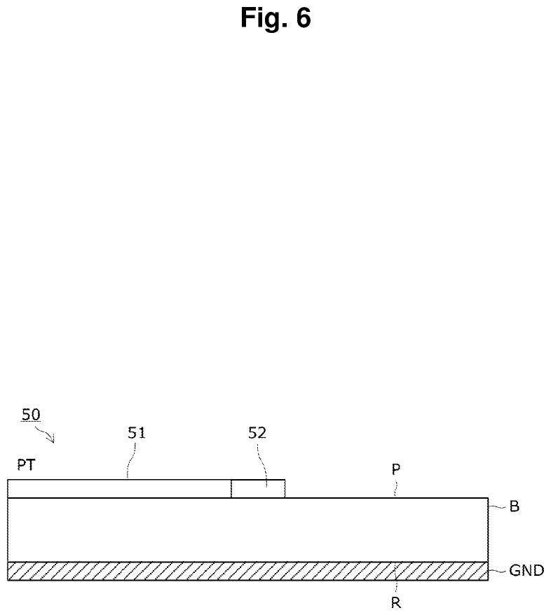

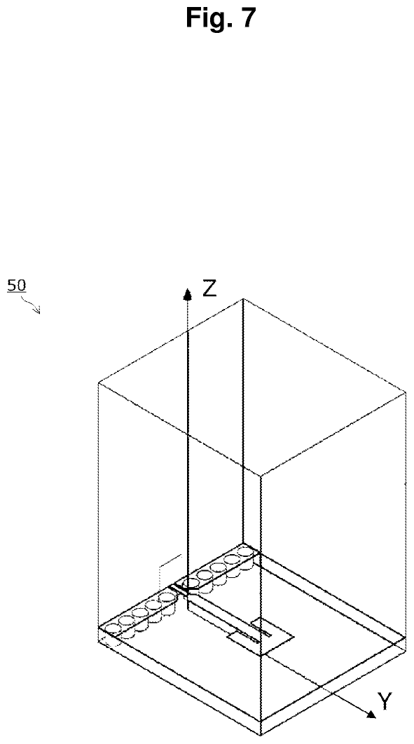

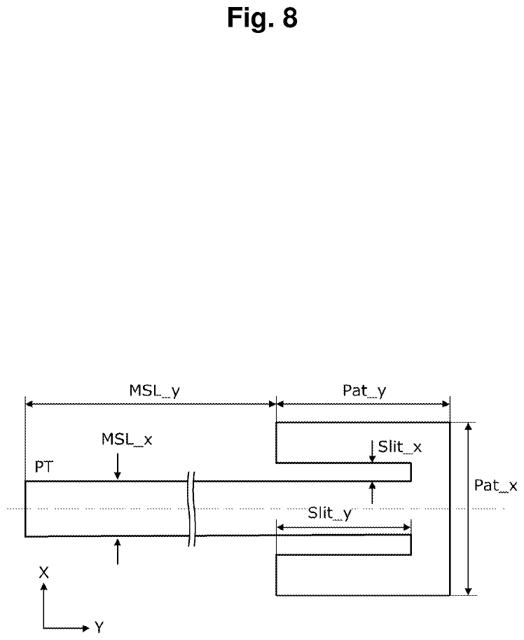

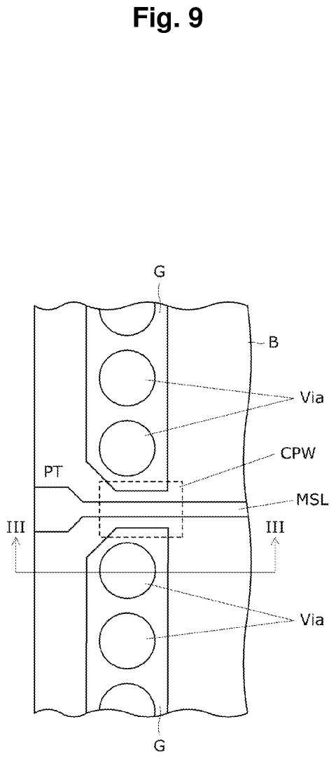

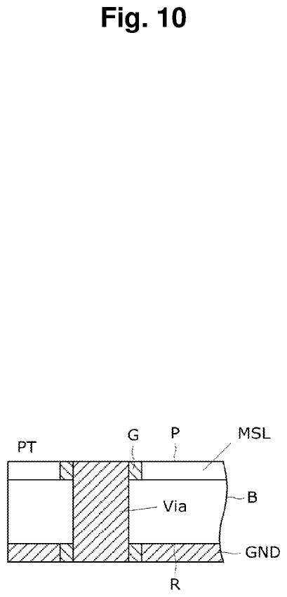

FIG. 3 is an explanatory diagram of the on-chip antenna according to the first embodiment. FIG. 4 is an explanatory diagram of an antenna size of the on-chip antenna according to the first embodiment. FIG. 5 is a plan view illustrating a configuration of the conventional patch antenna. FIG. 6 is a cross-sectional view taken along line II-II of FIG. 5. FIG. 7 is an explanatory diagram of the conventional patch antenna. FIG. 8 is an explanatory diagram of an antenna size of the conventional patch antenna. FIG. 9 is an enlarged view of a port portion. FIG. 10 is a cross-sectional view taken along line III-III of FIG. 9.

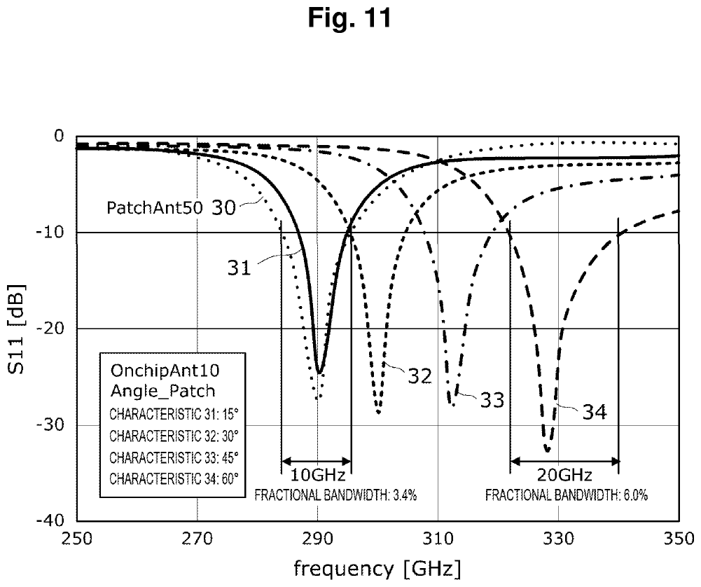

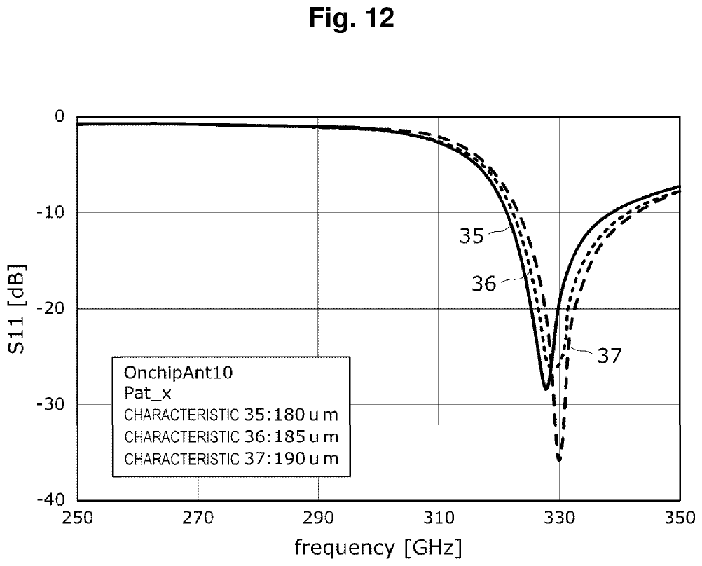

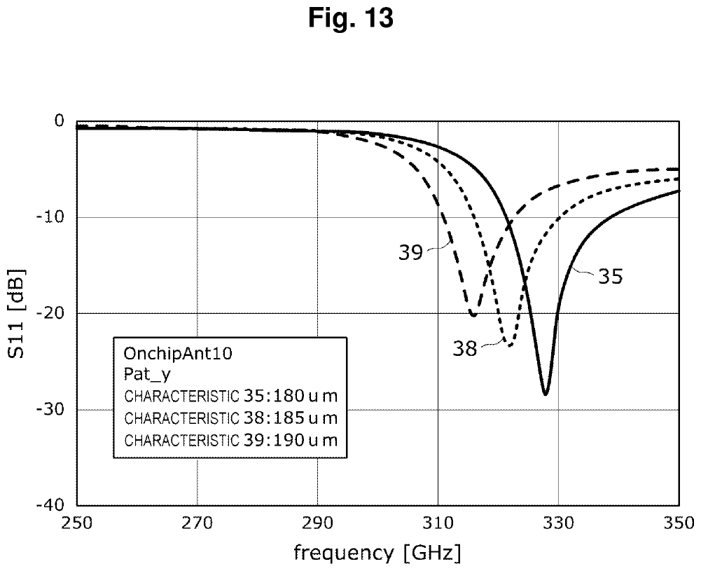

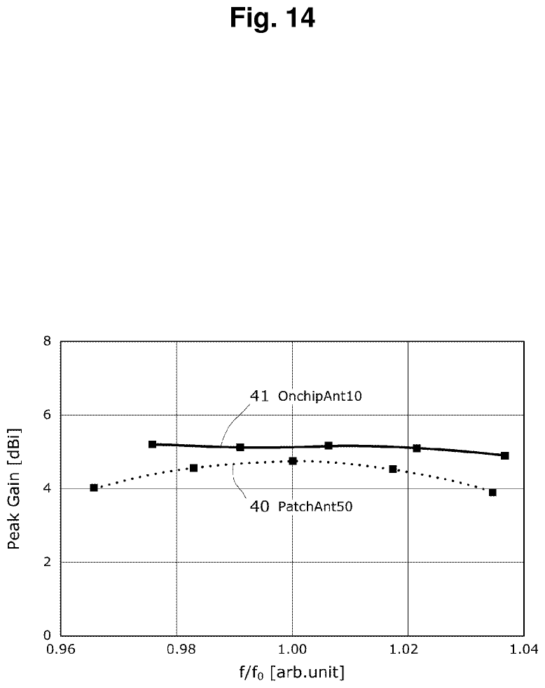

FIG. 11 is a graph showing changes (Angle_Patch) in return loss frequency characteristics regarding the on-chip antenna according to the first embodiment. FIG. 12 is a graph showing changes (Pat_x) in return loss frequency characteristics regarding the on-chip antenna according to the first embodiment. FIG. 13 is a graph showing changes (Pat_y) in return loss frequency characteristics regarding the on-chip antenna according to the first embodiment. FIG. 14 is a graph showing a gain characteristic regarding the on-chip antenna according to the first embodiment.

### Antenna Size

In the explanatory diagram of FIG. 3, a frequency band was set to 250 to 350 GHz as an analysis condition regarding the on-chip antenna 10 according to the present embodiment. Gold (Au) having a film thickness of 3 μm was used as the thin film conductors of the feed line 11, the patch conductor 12, and the stub conductors 13. An InP substrate having a thickness of 55 μm was used as the substrate B, and gold (Au) having a thickness of 4 μm was used as the ground plane GND. An electromagnetic field of 1 W was input from the port PT.

In the explanatory diagram of FIG. 4, regarding the antenna size of the on-chip antenna 10 according to the present embodiment, vertical and horizontal widths of the patch conductor 12, that is, patch sizes Pat_x and Pat_y were set to 180 μm, a width MSL_x of the feed line 11 was set to 41 μm, a length MSL_y thereof was set to 185 μm, a distance Stub_x between both the ends of the stub conductors 13 was set to 180 μm, and a strip width Stub_y of each stub conductor 13 was set to 20 μm. A width Slit_x of a slit 14 was set to 10 μm, a length Slit_y of the slit 14 was set to 55 μm, and a distance Stub_Int between the patch conductor 12 and the stub conductors 13 was set to 5 μm. Angles Angle_Patch between the side 12A and the inclined portions 12E and 12F were changed within the range of 15° to 60°.

Meanwhile, as illustrated in FIGS. 5 and 6, a conventional patch antenna 50 used as a comparison target includes a feed line 51 and a patch conductor 52 formed on a front surface P of a substrate B.

The feed line 51 includes a microstrip line such as a CPW as a whole and is a transmission line for feeding a high-frequency electromagnetic field input from the outside to the patch conductor 52.

The patch conductor 52 has a substantially square outer shape in a plan view as a whole and is an antenna element (radiating element) that radiates an electromagnetic field fed from the feed line 11. In the patch conductor 52, two slits 54 parallel to each other in the direction Y are formed in the vicinity of a connection portion of the feed line 51 so as to extend toward an inner region of the patch conductor 12. A laminated structure of the patch antenna 50 is similar to that in FIG. 2, and a ground plane GND is formed on a bottom surface R of the substrate B.

In the explanatory diagram of FIG. 7, a frequency band was set to 250 to 340 GHz as an analysis condition regarding the conventional patch antenna 50. Gold (Au) having a film thickness of 0.6 μm was used as thin film conductors of the feed line 51 and the patch conductor 52. An InP substrate having a thickness of 50 μm was used as the substrate B, and gold (Au) having a thickness of 4 μm was used as the ground plane GND. An electromagnetic field of 1 W was input from the port PT.

In the explanatory diagram of FIG. 8, regarding an antenna size of the conventional patch antenna 50, vertical and horizontal widths of the patch conductor 52, that is, a patch size Pat was set to 150 μm, a length MSL_y of the feed line 11 was set to 250 μm, a width Slit_x of the slit 55 was set to 10 μm, and a length Slit_y of the slit 55 was set to 93 μm.

For the analysis, as illustrated in FIGS. 9 and 10, a strip-shaped ground pattern G was formed in the direction X at an end on the port PT side of the front surface P of the substrate B on which the on-chip antenna 10 or patch antenna 50 was formed, and a plurality of via holes Via electrically connected to the ground plane GND on the rear surface R was arranged side by side. Therefore, a coplanar line CPW (coplanar waveguide) is formed in the feed line 11 or 51 in the vicinity of the ground pattern G.

A stub patch antenna, as well as the patch antenna, is fed from the microstrip line, and a feed point is adjusted by changing a value of Slit_y. A resonance frequency is changed depending on the size Pat_y of the patch in a feeding direction. Generally, a bandwidth of the patch antenna cannot be changed depending on its structure and is unintentionally determined depending on a material of the substrate to be mounted.

The on-chip antenna 10 includes the two symmetrical inclined portions 12E and 12F formed on a feeding side of the patch conductor 12 and the stub conductors 13 near the inclined portions 12E and 12F and is fed from the feed line 11 that is a microstrip line in a similar manner to the patch antenna. The resonance frequency of the on-chip antenna 10 can be matched by changing values of the sizes Slit_y and Stub_Int of the stub conductors 13. The center frequency and bandwidth of the on-chip antenna 10 can be changed by changing other structural parameters, and thus the on-chip antenna is more convenient than the patch antenna.

The electromagnetic field was actually analyzed on the basis of the analysis condition and the antenna size described above, and frequency characteristics of a return loss (S₁₁) shown in FIGS. 11 to 13 were obtained for both the on-chip antenna 10 and the patch antenna 50.

FIG. 11 shows characteristics in a case where Angle_Patch of the on-chip antenna 10 was changed. A characteristic 30 is an S₁₁ frequency characteristic of the patch antenna 50. Characteristics 31 to 34 are S₁₁ frequency characteristics of the on-chip antenna 10 in a case where Angle_Patch is 15°, 30°, 45°, and 60°. It can be seen from FIG. 11 that the bandwidth of the on-chip antenna 10 increases when a value of Angle_Patch is increased, and a fractional bandwidth of the on-chip antenna 10 is 2.6% larger than that of the patch antenna 50 in the case of 60°.

FIG. 12 shows characteristics in a case where Pat_x of the on-chip antenna 10 was changed, and characteristics 35 to 37 indicate S₁₁ frequency characteristics of the on-chip antenna 10 in a case where Pat_x was 180 μm, 185 μm, and 190 μm. It can be seen from FIG. 12 that the bandwidth of the on-chip antenna 10 increases when a value of Pat_x is increased. Here, because the feeding point Slit_y is fixed, the value of Pat_x is only slightly changed from the viewpoint of matching.

In the on-chip antenna 10, as described above, because the inclined portions 12E and 12F are inclined with respect to the direction X by the angle Angle_Patch, capacitances formed between the inclined portions 12E and 12F of the patch conductor 12 and the stub conductors 13 gradually change depending on positions thereof. It can be seen from the results of FIGS. 11 and 12 that the resonance frequency of the on-chip antenna 10 is widened due to the change in capacitances.

An effect of gradually changing and widening the resonance frequency can be similarly obtained in a case where the value of Angle_Patch is increased to make the angles of the inclined portions 12E and 12F steeper or in a case where the value of Pat_x is increased to expand the inclined portions 12E and 12F. In a case where the angles of the inclined portions 12E and 12F are made steeper, an amount of increase in bandwidth is larger, but the center frequency also shifts to a higher frequency. Meanwhile, in a case where the inclined portions 12E and 12F are expanded, the amount of increase in bandwidth is smaller, but a change in the center frequency is also smaller and is stable.

FIG. 13 shows characteristics in a case where Pat_y of the on-chip antenna 10 was changed, and characteristics 35, 38, and 39 indicate S₁₁ frequency characteristics of the on-chip antenna 10 in a case where Pat_y was 180 μm, 185 μm, and 190 μm. It can be seen from FIG. 13 that the bandwidth of the on-chip antenna 10 increases when a value of Pat_y is increased.

In FIG. 14, a characteristic 40 indicates a gain characteristic of the patch antenna 50, and a characteristic 41 indicates a gain characteristic of the on-chip antenna 10.

It can be seen from FIG. 13 that the resonance frequency of the on-chip antenna 10 tends to decrease when the value of Pat_y is increased. From this result, the on-chip antenna follows the operation principle similar to that of the conventional patch antenna 50 in that the resonance frequency is determined based on the antenna size in the feeding direction (direction Y). As shown in FIG. 14, it can be seen that the on-chip antenna 10 has a gain larger than that of the patch antenna 50 in the whole operating band, and the gain is stably improved in the widened operating band. A size ratio of the on-chip antenna 10 to the patch antenna 50 is about 1.2 times, and it can be seen that the structure of the on-chip antenna 10 efficiently widens the resonance frequency while minimizing an increase in size and increases an antenna effective area, thereby achieving both a wide band and a high gain.

### Second Embodiment

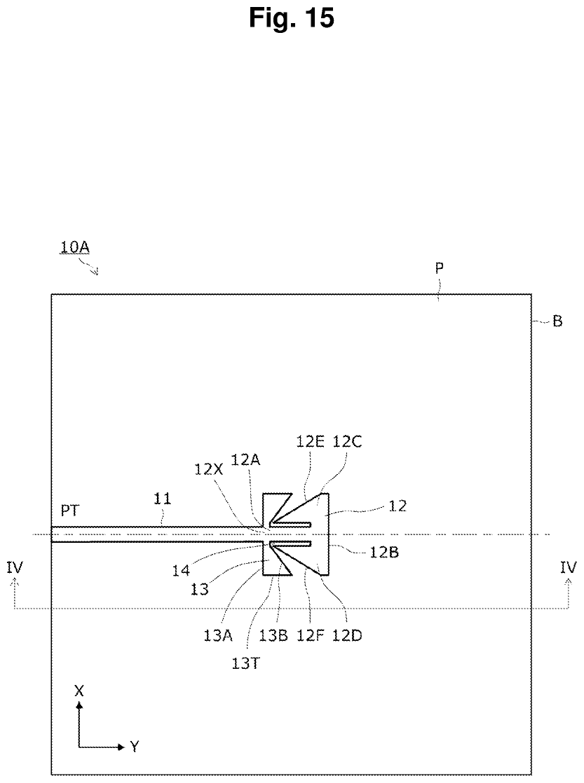

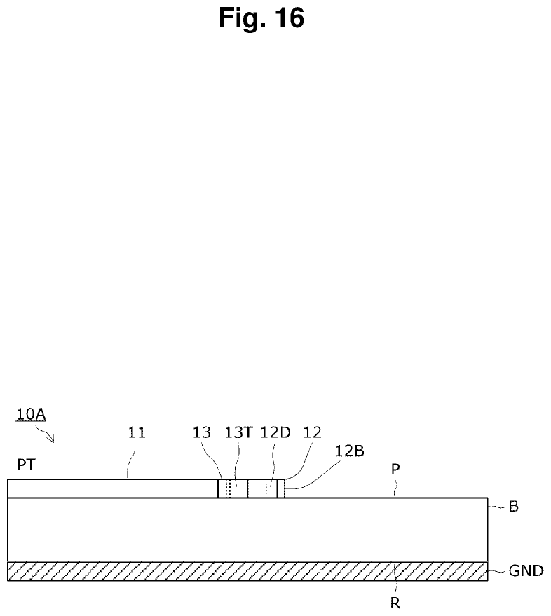

Next, an on-chip antenna 10A according to a second embodiment of the present invention will be described with reference to FIGS. 15 and 16. FIG. 15 is a plan view illustrating a configuration of the on-chip antenna according to the second embodiment. FIG. 16 is a cross-sectional view taken along line IV-IV of FIG. 1.

As illustrated in FIG. 15, the on-chip antenna 10A according to the present embodiment is such that, in the structure of the on-chip antenna 10 according to the first embodiment, the side 13A on the feed line 11 side of each stub conductor 13 protrudes from the feed line 11 in the direction X, i.e., in the direction perpendicular to the feed line, and the side 13B on the patch conductor 12 side thereof obliquely protrudes to expand from the feed line 11 toward the patch conductor 12.

Using such a structure can increase a degree of freedom in design and further improve convenience. In a case of the on-chip antenna 10, the center frequency tends to change when the bandwidth is expanded. Thus, the center frequency may not be matched when the bandwidth is widened in a desired frequency band, or the size of the on-chip antenna may be increased due to the expansion of the bandwidth. Meanwhile, using the on-chip antenna 10A makes it possible to widen the bandwidth while easily reducing an increase in the center frequency, without changing an area of the antenna.

### Operation Analysis According to Second Embodiment

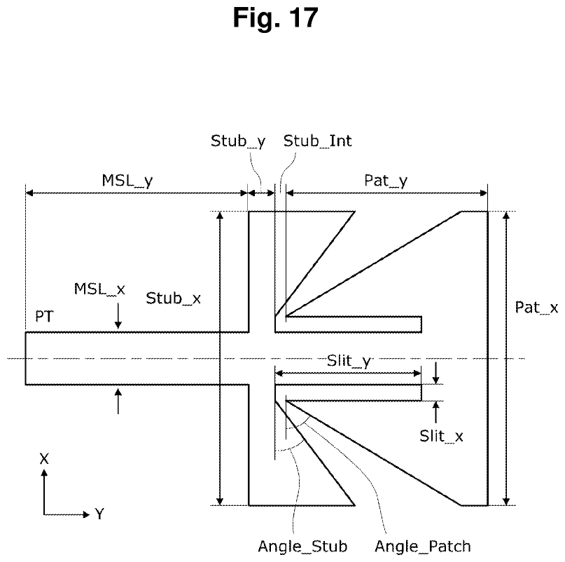

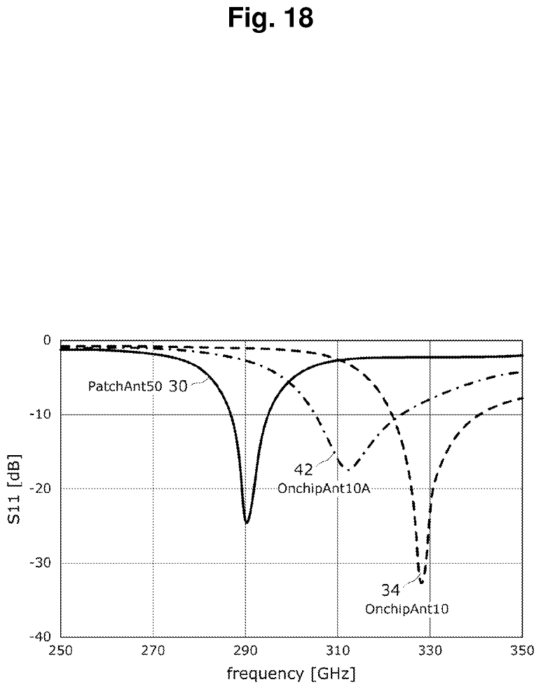

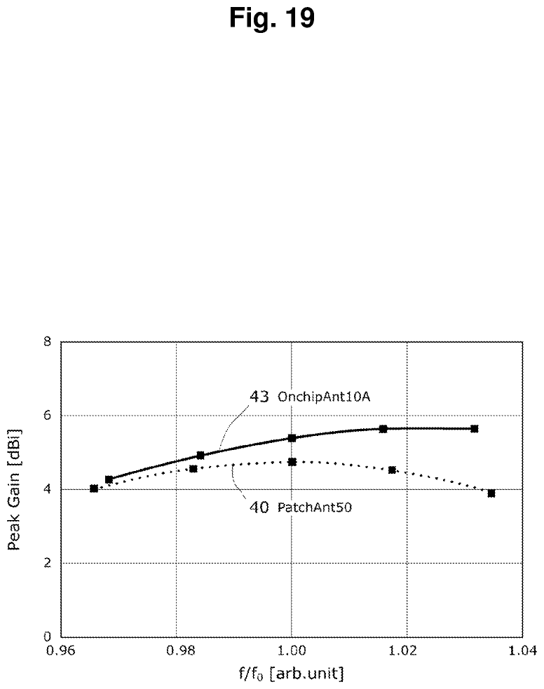

Next, an analysis result by simulation will be described as an operation of the on-chip antenna 10 according to the present embodiment with reference to FIGS. 17 to 19. FIG. 17 is an explanatory diagram of an analysis condition and antenna size of the on-chip antenna according to the second embodiment. FIG. 18 is a graph showing a return loss frequency characteristic regarding the on-chip antenna according to the second embodiment. FIG. 19 is a graph showing a gain characteristic regarding the on-chip antenna according to the second embodiment.

### Antenna Size

In FIG. 17, a frequency band was set to 250 to 350 GHz as an analysis condition regarding the on-chip antenna 10A according to the present embodiment. Gold (Au) having a film thickness of 3 μm was used as the thin film conductors of the feed line 11, the patch conductor 12, and the stub conductors 13. An InP substrate having a thickness of 55 μm was used as the substrate B, and gold (Au) having a thickness of 4 μm was used as the ground plane GND. An electromagnetic field of 1 W was input from the port PT.

In FIG. 17, regarding the antenna size of the on-chip antenna 10A according to the present embodiment, vertical and horizontal widths of the patch conductor 12, that is, the patch sizes Pat_x and Pat_y were set to 180 μm, the width MSL_x of the feed line 11 was set to 41 μm, the length MSL_y thereof was set to 185 μm, the distance Stub_x between both the ends of the stub conductors 13 was set to 180 μm, and the strip width Stub_y of each stub conductor 13 was set to 20 μm. The width Slit_x of the slit 14 was set to 10 μm, the length Slit_y of the slit 14 was set to 55 μm, and the distance Stub_Int between the patch conductor 12 and the stub conductors 13 was set to 5 μm. Angle_Patch of each of the inclined portions 12E and 12F with respect to the direction X was set to 60°, and Angle_Stub of the side 13B with respect to the direction X was set to 36°.

For the analysis, as illustrated in FIGS. 9 and 10 described above, the strip-shaped ground pattern G was formed in the direction X at the end on the port PT side of the front surface P of the substrate B on which the on-chip antenna 10A was formed, and a plurality of via holes Via electrically connected to the ground plane GND on the rear surface R was arranged side by side. Therefore, the coplanar line CPW (coplanar waveguide) is formed in the feed line 11 or 51 in the vicinity of the ground pattern G.

The electromagnetic field was actually analyzed on the basis of the analysis condition and the antenna size described above, and characteristics shown in FIGS. 18 and 19 were obtained for the on-chip antenna 10A.

In FIG. 18, the characteristic 30 indicates the S₁₁ frequency characteristic of the patch antenna 50, the characteristic 34 indicates the S₁₁ frequency characteristic of the on-chip antenna 10, and a characteristic 42 indicates an S₁₁ frequency characteristic of the on-chip antenna 10A. It can be seen from FIG. 18 that, when the on-chip antenna 10A is used, it is possible to maintain a wide band while reducing the center frequency, without substantially changing the size of the antenna.

In FIG. 19, the characteristic 40 indicates the gain characteristic of the patch antenna 50, and a characteristic 43 indicates a gain characteristic of the on-chip antenna 10A. It can be seen from FIG. 19 that the gain can be stably increased in a wide band, as compared with the patch antenna 50. In particular, as an antenna element, the on-chip antenna maintains a small size of a ¼ wavelength or less with respect to the center frequency of 315 GHz (wavelength 952 um). This makes it possible to array the on-chip antennas in a similar manner to the patch antennas while achieving both a wide band and a high gain.

### Phased Array Antenna

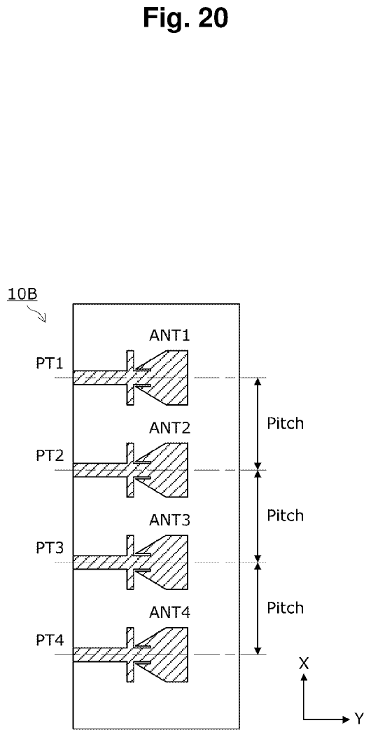

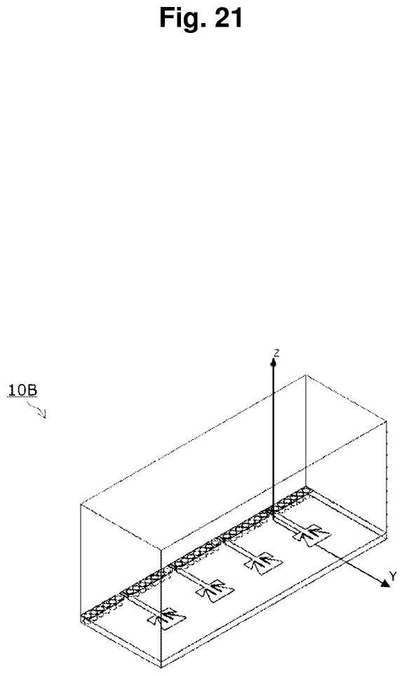

Next, a phased array antenna 10B according to the present embodiment will be described with reference to FIGS. 20 and 21. FIG. 20 is a plan view illustrating a configuration of the phased array antenna including the on-chip antennas according to the second embodiment. FIG. 21 is a perspective view of FIG. 20.

s illustrated in FIG. 20, in the phased array antenna 10B, antenna elements ANT1 to ANT4 each including the on-chip antenna 10A are arrayed in 1×4 in the direction X at pitches of 470 um on the same substrate B.

Individual ports PT1 to PT4 are provided for the antenna elements ANT1 to ANT4, respectively. A plurality of high frequency signals having the same phase or different phases, which is input as a combination from the ports PT1 to PT4, is fed to each of the antenna elements ANT1 to ANT4 via individual feed lines. Because the antenna size is small, the pitches between the antenna elements ANT1 to ANT4 can be about a half wavelength of a radio wave in a target frequency band.

The antenna elements ANT1 to ANT4 can be periodically arrayed one-dimensionally or two-dimensionally in a direction different from the feeding direction (direction Y) of each feed line. Further, a structure in which the antenna elements ANT1 to ANT4 are periodically arrayed one-dimensionally in the feeding direction (direction Y) of each feed line is set as one unit, and the above structures can also be periodically arrayed one-dimensionally or two-dimensionally in a direction different from the feeding direction of each feed line.

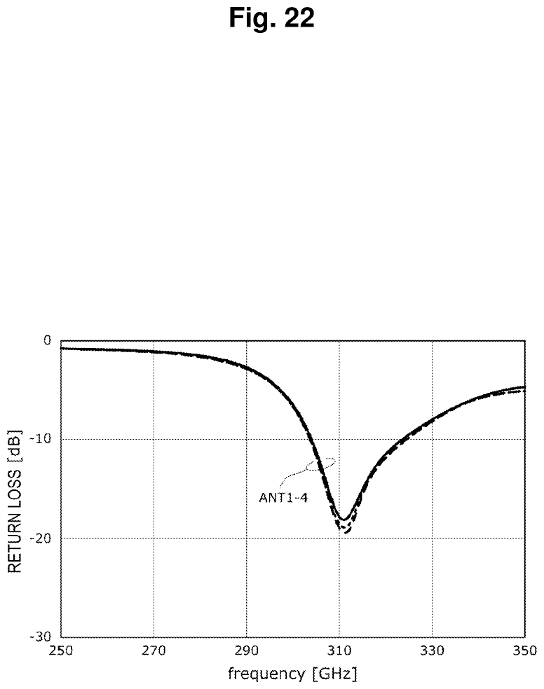

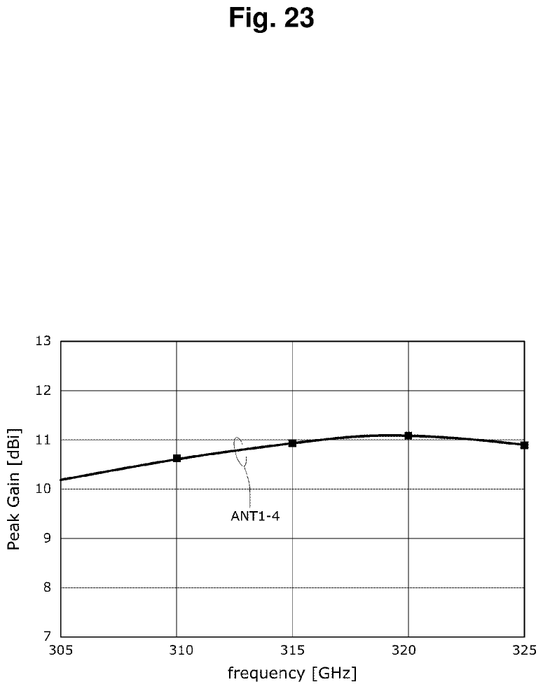

The on-chip antennas 10A were arrayed to form the phased array antenna 10B in this way, and an electromagnetic field was analyzed. FIG. 22 is a graph showing a return loss frequency characteristic regarding the phased array antenna according to the second embodiment. FIG. 23 is a graph showing a gain characteristic regarding the phased array antenna according to the second embodiment.

FIGS. 22 and 23 show characteristics when power was individually supplied from the ports PT1 to PT4 to the antenna elements ANT1 to ANT4 one by one.

According to FIGS. 22 and 23, any of the antenna elements ANT1 to ANT4 shows an S₁₁ frequency characteristic matching with that of the single on-chip antenna 10A indicated as the characteristic 42 in FIG. 18 and a gain characteristic matching with that of the single on-chip antenna 10A indicated as the characteristic 42 in FIG. 18 described above. Therefore, it can be seen that the same characteristics as those of the on-chip antenna 10A are obtained even in a case where the antenna elements are arrayed, and, as a result, the antenna elements ANT1 to ANT4 are reliable.

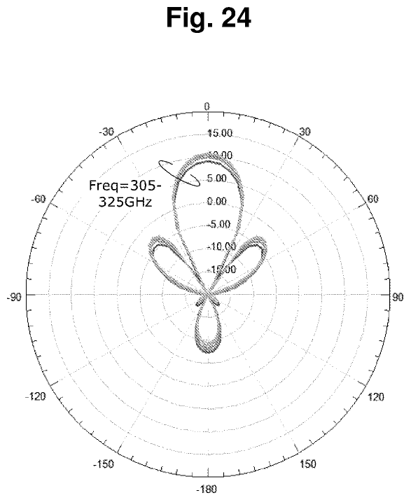

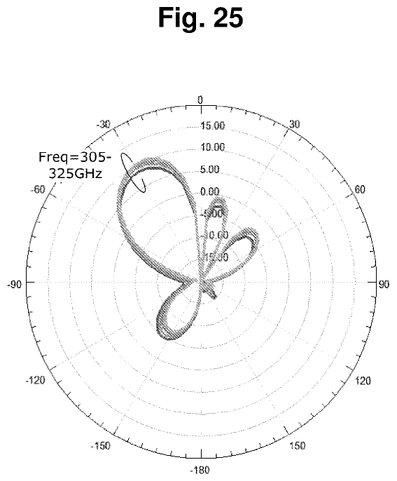

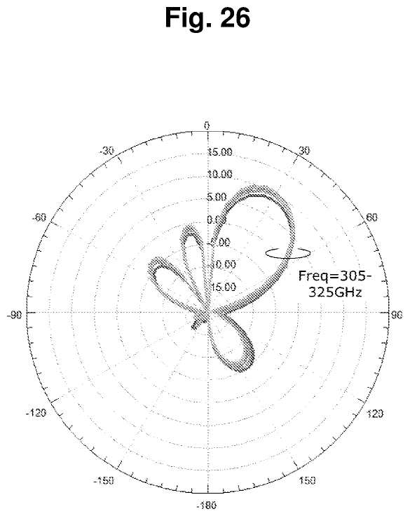

In the phased array antenna 10B, radiation characteristics obtained when power was simultaneously supplied to the antenna elements ANT1 to ANT4 from the ports PT1 to PT4 were confirmed. FIG. 24 is a graph showing a radiation characteristic (front radiation) regarding the phased array antenna according to the second embodiment. FIG. 25 is a graph showing a radiation characteristic (left radiation) regarding the phased array antenna according to the second embodiment. FIG. 26 is a graph showing a radiation characteristic (right radiation) regarding the phased array antenna according to the second embodiment.

Among the above drawings, FIG. 24 illustrates the radiation characteristic when a beam direction was front, and FIGS. 25 and 26 illustrate the radiation characteristics when the beam direction was changed to the left and right. It can be seen from FIGS. 24 to 26 that a gain of about 11 dBi is obtained in most bands (305 GHz to 325 GHz) regardless of the beam direction. Because an average gain of the elements is about 5 dBi, it can be confirmed that the phased array antenna obtains a gain substantially close to a theoretical value in consideration of an array gain of 6 dBi and has a configuration in which a loss caused by inter-element coupling or the like is small. That is, it can be seen from the above verification that the on-chip antenna 10A is a highly convenient antenna that can be arrayed in a similar manner to the patch antenna to form a phased array antenna while maintaining a wide band and high gain of the elements.

### Advantageous Effects of Invention

As described above, the present invention can improve the directivity and gain of the on-chip antenna. This makes it possible to perform wireless communication over a longer distance. Because a wideband radiation characteristic can be obtained, an increase in capacity of wireless communication in the millimeter wave band/terahertz band throughout the entire system can be expected by increasing an amount of transmittable information. From the viewpoint of chip design, it is possible to tune the center frequency and the bandwidth without substantially changing the size of the antenna. Therefore, the chip antenna is highly convenient from the viewpoint of system design. It is possible to reduce the size and improve the gain and radiation efficiency in a wide band.

Both the on-chip antennas 10 and 10A according to the present invention have a small size, and thus it is also possible to easily achieve both improvement in the above characteristics and array as in the phased array antenna 10B, for example. At that time, the element size can be designed to be a ¼ wavelength or less, and thus it is possible to reduce a problem such as electromagnetic field coupling between the elements and double a gain improvement effect of a single element according to the number of elements. Further, because the antennas are arrayed, it is possible to obtain a gain equal to or higher than that of a conventional wideband antenna designed to have a wavelength size, such as a Vivaldi antenna, and automatically control a radiation direction by beamforming. For example, assuming ultra-high speed wireless communication in the 300 GHz band, a slight deviation of a transmission/reception position greatly affects the SN ratio, and thus, when the SN ratio is constantly optimized by finely adjusting a beam angle, it is possible to perform high bit rate wireless transmission at a high modulation level.

### Extension of Embodiments

The present invention has been described by referring to the embodiments, but is not limited to the above embodiments. Various changes understandable by those skilled in the art can be made for the configurations and details of the present invention within the scope of the present invention. In addition, each embodiment can be implemented in any combination within a consistent range.

### REFERENCE SIGNS LIST

10, 10A On-chip antenna
10B Phased array antenna
11 Feed line
12 Patch conductor
12A, 12B Side
12C, 12D Side
12E, 12F Inclined portion
12R Rectangle
12S Corner
12X Connection portion
13 Stub conductor
13A, 13B Side
14 Slit
ANT1 to ANT4 Antenna element
PT, PT1 to PT4 Port
B Substrate
P Front surface
R Bottom surface
GND Ground plane

1. An on-chip antenna comprising:
a substrate made from a dielectric;
a patch conductor formed on a front surface of the substrate and configured to radiate a fed electromagnetic field;
a feed line formed on the front surface of the substrate and configured to feed an input electromagnetic field to the patch conductor; and
a pair of stub conductors formed on the front surface of the substrate and provided to symmetrically protrude from the feed line in the vicinity of a connection portion where the feed line is connected to the patch conductor, wherein
the patch conductor has a hexagonal shape in which both corners of one side of a rectangle are obliquely cut off, and the one side is connected to the feed line at the connection portion.

2. The on-chip antenna according to claim 1, wherein
a distance between both ends of the pair of stub conductors is substantially the same as a distance between the pair of sides of the patch conductor.

3. The on-chip antenna according to claim 1, wherein
each of the pair of stub conductors has a certain width equal to or less than a line width of the feed line and protrudes from the feed line in a direction perpendicular to the feed line.

4. The on-chip antenna according to claim 1, wherein
one side of each of the pair of stub conductors protrudes from the feed line in a direction perpendicular to the feed line, and the other side of each of the pair of stub conductors obliquely protrudes to expand from the feed line toward the patch conductor.

5. The on-chip antenna according to claim 1, further comprising
two parallel slits formed in the vicinity of the connection portion so as to protrude toward inside of the patch conductor.

6. A phased array antenna comprising:
a plurality of the on-chip antennas according to claim 1; and
a plurality of feed lines configured to individually supply a high frequency signal to the plurality of on-chip antennas, respectively, wherein:
the plurality of on-chip antennas is periodically arrayed one-dimensionally or two-dimensionally at an interval of about a half wavelength of a radio wave in a target frequency band in a direction different from a feeding direction of the plurality of feed lines; and
the plurality of feed lines individually feed each of a plurality of radio frequency signals having a same phase or different phases to a corresponding on-chip antenna of the plurality of on-chip antennas.

7. A phased array antenna comprising:
a plurality of the on-chip antennas according to claim 1; and
a plurality of feed lines configured to individually supply a high frequency signal to the plurality of on-chip antennas, respectively, wherein:
a structure in which the plurality of on-chip antennas is periodically arrayed one-dimensionally in a feeding direction of the plurality of feed lines serves as one unit, and the structures are periodically arrayed one-dimensionally or two-dimensionally in a direction different from the feeding direction of the plurality of feed lines; and
the plurality of feed lines individually feed each of a plurality of radio frequency signals having a same phase or different phases to a corresponding on-chip antenna of the plurality of on-chip antennas.

8. The on-chip antenna according to claim 2, wherein
each of the pair of stub conductors has a certain width equal to or less than a line width of the feed line and protrudes from the feed line in a direction perpendicular to the feed line.

9. A phased array antenna comprising:
a plurality of the on-chip antennas according to claim 2; and
a plurality of feed lines configured to individually supply a high frequency signal to the plurality of on-chip antennas, respectively, wherein:
the plurality of on-chip antennas is periodically arrayed one-dimensionally or two-dimensionally at an interval of about a half wavelength of a radio wave in a target frequency band in a direction different from a feeding direction of the plurality of feed lines; and
the plurality of feed lines individually feed each of a plurality of radio frequency signals having a same phase or different phases to a corresponding on-chip antenna of the plurality of on-chip antennas.

10. A phased array antenna comprising:
a plurality of the on-chip antennas according to claim 3; and
a plurality of feed lines configured to individually supply a high frequency signal to the plurality of on-chip antennas, respectively, wherein:
the plurality of on-chip antennas is periodically arrayed one-dimensionally or two-dimensionally at an interval of about a half wavelength of a radio wave in a target frequency band in a direction different from a feeding direction of the plurality of feed lines; and
the plurality of feed lines individually feed each of a plurality of radio frequency signals having a same phase or different phases to a corresponding on-chip antenna of the plurality of on-chip antennas.

11. A phased array antenna comprising:
a plurality of the on-chip antennas according to claim 4; and
a plurality of feed lines configured to individually supply a high frequency signal to the plurality of on-chip antennas, respectively, wherein:
the plurality of on-chip antennas is periodically arrayed one-dimensionally or two-dimensionally at an interval of about a half wavelength of a radio wave in a target frequency band in a direction different from a feeding direction of the plurality of feed lines; and
the plurality of feed lines individually feed each of a plurality of radio frequency signals having a same phase or different phases to a corresponding on-chip antenna of the plurality of on-chip antennas.

12. A phased array antenna comprising:
a plurality of the on-chip antennas according to claim 5; and
a plurality of feed lines configured to individually supply a high frequency signal to the plurality of on-chip antennas, respectively, wherein:
the plurality of on-chip antennas is periodically arrayed one-dimensionally or two-dimensionally at an interval of about a half wavelength of a radio wave in a target frequency band in a direction different from a feeding direction of the plurality of feed lines; and
the plurality of feed lines individually feed each of a plurality of radio frequency signals having a same phase or different phases to a corresponding on-chip antenna of the plurality of on-chip antennas.

13. A phased array antenna comprising:
a plurality of the on-chip antennas according to claim 2; and
a plurality of feed lines configured to individually supply a high frequency signal to the plurality of on-chip antennas, respectively, wherein:
a structure in which the plurality of on-chip antennas is periodically arrayed one-dimensionally in a feeding direction of the plurality of feed lines serves as one unit, and the structures are periodically arrayed one-dimensionally or two-dimensionally in a direction different from the feeding direction of the plurality of feed lines; and
the plurality of feed lines individually feed each of a plurality of radio frequency signals having a same phase or different phases to a corresponding on-chip antenna of the plurality of on-chip antennas.

14. A phased array antenna comprising:
a plurality of the on-chip antennas according to claim 3; and
a plurality of feed lines configured to individually supply a high frequency signal to the plurality of on-chip antennas, respectively, wherein:
a structure in which the plurality of on-chip antennas is periodically arrayed one-dimensionally in a feeding direction of the plurality of feed lines serves as one unit, and the structures are periodically arrayed one-dimensionally or two-dimensionally in a direction different from the feeding direction of the plurality of feed lines; and
the plurality of feed lines individually feed each of a plurality of radio frequency signals having a same phase or different phases to a corresponding on-chip antenna of the plurality of on-chip antennas.

15. A phased array antenna comprising:
a plurality of the on-chip antennas according to claim 4; and
a plurality of feed lines configured to individually supply a high frequency signal to the plurality of on-chip antennas, respectively, wherein:
a structure in which the plurality of on-chip antennas is periodically arrayed one-dimensionally in a feeding direction of the plurality of feed lines serves as one unit, and the structures are periodically arrayed one-dimensionally or two-dimensionally in a direction different from the feeding direction of the plurality of feed lines; and
the plurality of feed lines individually feed each of a plurality of radio frequency signals having a same phase or different phases to a corresponding on-chip antenna of the plurality of on-chip antennas.

16. A phased array antenna comprising:
a plurality of the on-chip antennas according to claim 5; and
a plurality of feed lines configured to individually supply a high frequency signal to the plurality of on-chip antennas, respectively, wherein:
a structure in which the plurality of on-chip antennas is periodically arrayed one-dimensionally in a feeding direction of the plurality of feed lines serves as one unit, and the structures are periodically arrayed one-dimensionally or two-dimensionally in a direction different from the feeding direction of the plurality of feed lines; and
the plurality of feed lines individually feed each of a plurality of radio frequency signals having a same phase or different phases to a corresponding on-chip antenna of the plurality of on-chip antennas.
